(19) United States
(12) Patent Application Publication
(10) Pub. No.: US 2012/0026029 A1
(43) Pub. Date: Feb. 2, 2012

(54) MOTION DETECTION SYSTEM AND METHOD WITH NULL POINTS

(75) Inventors: Philip Andrew Rudland, Sunderland (GB); David M. Avery, Woking (GB); Paul Farrow, Sutton (GB); Peter Stephen May, Maidstone (GB)

(73) Assignee: KONINKLIJKE PHILIPS ELECTRONICS N.V., EINDHOVEN (NL)

(21) Appl. No.: 13/148,862

(22) PCT Filed: Jan. 26, 2010
(86) PCT No.: PCT/IB10/50340

§ 371 Date: Aug. 10, 2011

Related U.S. Application Data
(60) Provisional application No. 61/151,591, filed on Feb. 11, 2009.

(51) Int. Cl. G01S 13/04

(52) U.S. Cl. 342/28

(57) ABSTRACT

A motion detection system and method with null points with a motion detection method including transmitting a signal (102); detecting the signal at a first device (104); determining whether signal strength of the detected signal is less than an expected signal strength (106); transmitting at least one additional signal (108); detecting the at least one additional signal at the first device (110); determining whether signal strength of the detected at least one additional signal is less than the expected signal strength (112); and determining that the first device is in a null point when the signal strength of the detected signals is less than the expected signal strength for a predetermined number of the detected signals (114).

The technical field of this disclosure is motion detection systems and methods, particularly, motion detection systems and methods with null points.

Wireless communication and control networks are becoming increasingly popular for home automation, building automation, healthcare infrastructure, low power cable-less links, asset control, and other applications. One benefit of such networks is the ability to locate a network device or tag. For example, lighting commissioning personnel can quickly identify a specific wireless device, so installation costs can be reduced. Expensive equipment may be tagged, and tracked in and around a building, allowing staff to easily locate the tagged equipment when needed for use, for calibration, or in an emergency. Tagged equipment can also generate an alarm when moved beyond specified boundaries.

Although a number of methods are available to determine locations of mobile devices, such as asset tags, or fixed devices, such as lights or control units, all require that one device transmit a message and another device receive the message. Unfortunately, transmitting and receiving messages requires power. In battery powered devices, battery life is directly affected by the amount of time spent transmitting or receiving messages. This is particularly true for applications requiring real time location information, such as small form factor/high volume asset tags, for which battery capacity is limited. Precise location must be sacrificed for available battery capacity.

One approach has been to equip each asset tag with a mercury switch or an accelerometer, which is used to determine whether the asset tag is moving. The rate of transmitting messages and the time spent receiving messages is reduced when the accelerometer indicates that the asset tag is not moving. Unfortunately, equipping each asset tag with a mercury switch or accelerometer increases the number of parts, increasing the cost, assembly time, and complexity of the asset tag.

One problem encountered in range estimation for wireless communication and control networks is the presence of null points in the signal field. Original signals and reflected signals cancel each other at the null points. Because range estimation often depends on the orderly, regular decay of signal strength to determine distance, the null points are anomalies in the signal field and create errors in range estimation. The presence of null points is undesirable in range estimation and requires corrective measures for accuracy.

It would be desirable to have a motion detection system and method with null points that would overcome the above disadvantages.

One aspect of the present invention relates to a motion detection method including transmitting a signal; detecting the signal at a first device; determining whether signal strength of the detected signal is less than an expected signal strength; transmitting at least one additional signal; detecting the at least one additional signal at the first device; determining whether signal strength of the detected at least one additional signal is less than the expected signal strength; and determining that the first device is in a null point when the signal strength of the detected signals is less than the expected signal strength for a predetermined number of the detected signals.

Another aspect of the present invention relates to a motion detection system including a first device operable to transmit a signal; a second device operable to detect the signal; and a processor operable to determine whether signal strength of detected signals at the second device is less than an expected signal strength, and operable to determine that the second device is in a null point when the signal strength of the detected signals is less than the expected signal strength for a predetermined number of the detected signals.

Yet another aspect of the present invention relates to a motion detection method including transmitting a first signal; detecting the first signal at a plurality of first devices; determining a greatest signal strength of the first signal detected by the plurality of first devices; determining that one of the plurality of first devices is in a null point when signal strength of the detected first signal at the one of the plurality of first devices is less than the greatest signal strength less a predetermined signal strength offset; transmitting a second signal; detecting the second signal at the plurality of first devices; determining that the one of the plurality of first devices is in the null point when signal strength of the detected second signal at the one of the plurality of first devices is less than the greatest signal strength less the predetermined signal strength offset; and determining that the one of the plurality of first devices is stationary when the one of the plurality of first devices is in the null point for the first signal and the second signal.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

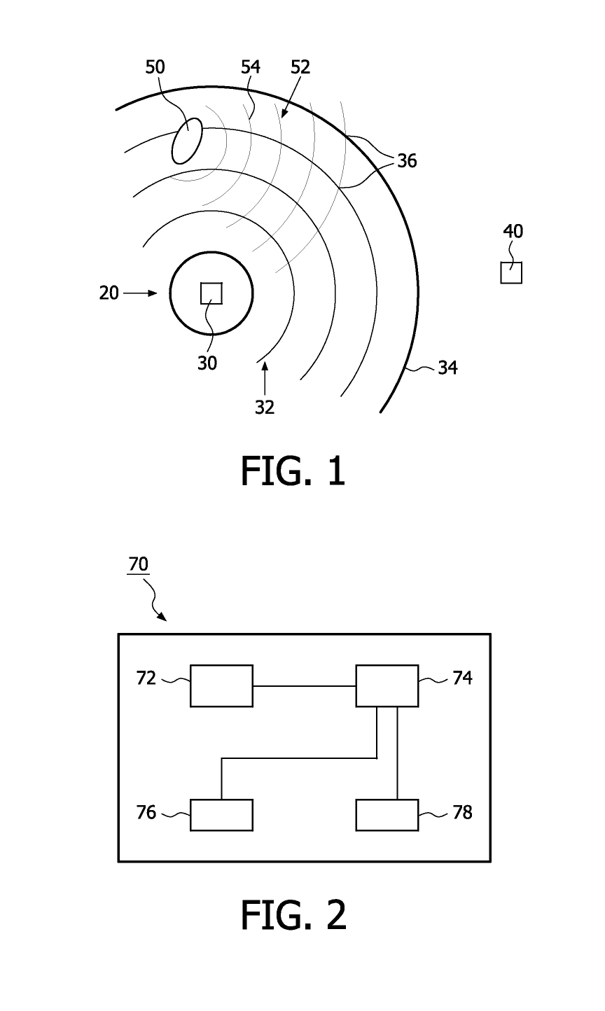

FIG. 1 is a schematic diagram of a motion detection system in accordance with the present invention;

FIG. 2 is a block diagram of a radio frequency (RF) unit for use with a motion detection system and method in accordance with the present invention;

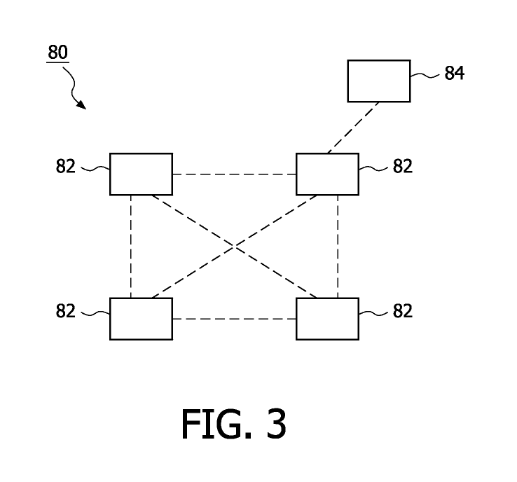

FIG. 3 is a block diagram of a motion detection system in accordance with the present invention; and

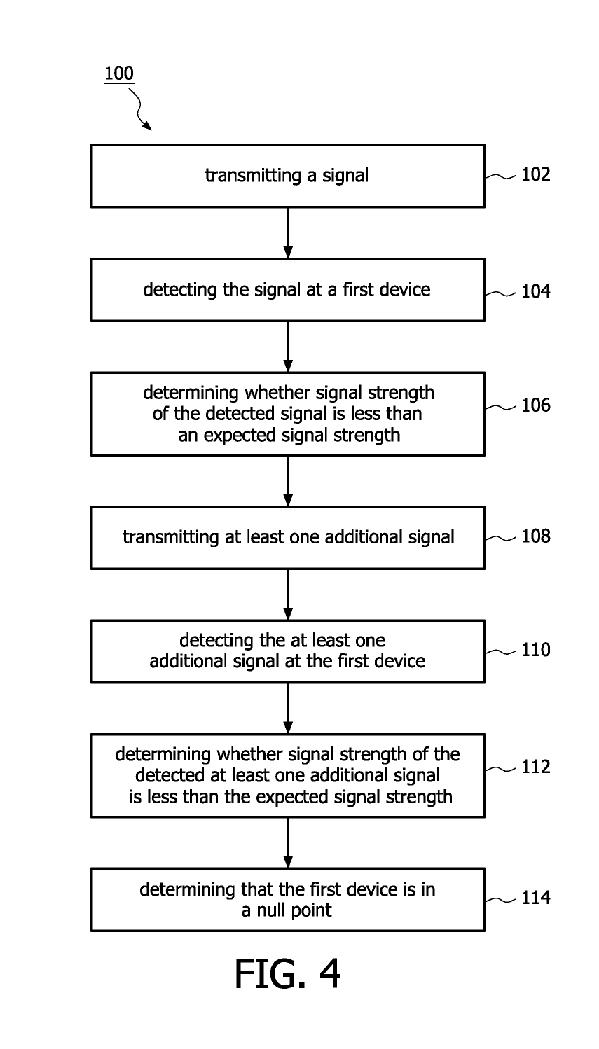

FIG. 4 is a flowchart of a motion detection method in accordance with the present invention.

FIG. 1 is a schematic diagram of a motion detection system in accordance with the present invention. In this example, a transmitter transmits a signal detected by a receiver, which determines when the receiver is in a null point and stationary with respect to the transmitter. Referring to FIG. 1, in one embodiment, the motion detection system 20 includes a transmitter 30 and a receiver 40. The transmitter 30 transmits a source signal 32 including source troughs 34 at which the source signal 32 is a minimum. The receiver 40 is operable to detect signals at the carrier frequency of the source signal 32. In some embodiments, the transmitter 30 can transmit signals over a range of carrier frequencies and the receiver 40 detects signals over a range of carrier frequencies, so the motion detection system 20 can shift carrier frequencies during operation. The source signal 32 reflects from an interfering object 50 as a reflected signal 52 including reflected peaks 54 at which the reflected signal 52 is a maximum. Superposition of the source signal 32 and the reflected signal 52 results in variations in signal strength about the transmitter 30 and receiver 40. Null points 36 occur when a source trough 34 intersects with a reflected peak 54. The signal strength at the null points 36 is minimal because the source signal 32 and reflected signal 52 cancel each other.

Interference between the source signal 32 and the reflected signal 52 creates the null points 36. The null points 36 tend to be small in size (typically a few centimeters or less for a 2.4 GHz signal), which makes the position of the null point sensitive to even a very small movement of the transmitter 30, the receiver 40, and/or the interfering object 50. When the receiver 40 is located in a null point, a very small movement of the receiver 40 moves the receiver 40 out of the null point. In addition, an object moving into the area around the transmitter 30, interfering object 50, or the receiver 40 can interfere with the source signal 32 and/or the reflected signal 52, causing the null point to move or disappear. Once a receiver is identified as being in a null point, the receiver can be determined to be in a null point and stationary with respect to the transmitter when the signal strength of the detected signal is less than the expected signal strength for a predetermined number of detected signals.

The transmitter 30 and/or the receiver 40 can be fixed or moveable as desired for a particular application. In one embodiment, the motion detection system 20 includes a number of transmitters and/or receivers. The transmitters and/or receivers are located within an area, i.e., the transmitters and/or receivers are located to communicate with each other and establish a field including null points. The transmitter 30 and the receiver 40 can be combined in a single radio frequency (RF) unit when there are a number of transmitters and/or receivers. The transmitter 30 and the receiver 40 can communicate using any desired protocol, such as a ZigBee protocol operating on top of the IEEE 802.15.4 wireless standard, WiFi protocol under IEEE standard 802.11 (such as 802.11b/g/n), Bluetooth protocol, Bluetooth Low Energy protocol, or the like. In one embodiment, the transmitters and/or receivers can be arranged in a predetermined pattern, such as approximate collocation of at least three transmitters and/or receivers to assure that the area of interest is covered by the source and reflected signals.

Approximate collocation as defined herein as arrangement of at least three transmitters and/or receivers so that at least two of the transmitters and/or receivers are unobstructed at any time, even when one of the transmitters and/or receivers is obstructed. Approximate collocation assures that at least two of the transmitters and/or receivers are available to process the signal even when an interfering object, such as a metal plate, wall, person, or other object, is near one of the transmitters or receivers and obstructs the signal to another transmitter or receiver. This assures that the motion detection system has sufficient information to estimate an expected signal strength when the expected signal strength is based on current or prior signals. In one embodiment, the approximately collocated transmitters and/or receivers are arranged along a line. In another embodiment, the approximately collocated transmitters and/or receivers are enclosed within a single enclosure.

In the example of FIG. 1, the transmitter 30 and the receiver 40 are located in the middle of an open space, so the line-of-sight signal strength of a message received from the receiver 40 at the transmitter 30 as the source signal 32 along a first signal path is a certain value X. When a metal plate, wall, person, or other reflective object is positioned near the transmitter 30 and receiver 40 as an interfering object 50, a second signal path is created from the transmitter 30 to the receiver 40, i.e., the signal path from the transmitter 30 to the interfering object 50 and from the interfering object 50 to the receiver 40. The path length of the first and second signal paths are different. At some points, the source signal 32 and the reflected signal 52 combine positively, producing a signal larger than the certain value X (perhaps even twice X). At other points, the source signal 32 and the reflected signal 52 are out of phase, producing a signal smaller than the certain value X (perhaps even a null signal). The receiver 40 is in a null position with respect to the transmitter 30 when the signal at the receiver 40 is at or near a null. Those skilled in the art will appreciate that FIG. 1 is a simplification of the situation typically present for a motion detection system. Typically, a number of reflecting objects, such as several walls, are present at any location, so the null points occur in a varied and irregular pattern. The null points are very small, e.g., a few centimeters or less for a 2.4 GHz signal, making them useful for detecting small motions and/or lack of motion.

FIG. 2 is a block diagram of a radio frequency (RF) unit for use with a motion detection system and method in accordance with the present invention. In this example, the RF unit can be a transmitter, a receiver, or a transmitter and receiver, and can be moveable or fixed. The motion detection system includes a first device, such as a transmitter, operable to transmit a signal; a second device, such as a receiver, operable to detect the signal; and a processor operable to determine whether signal strength of detected signals at the second device is less than an expected signal strength, and operable to determine that the second device is in a null point when the signal strength of the detected signals is less than the expected signal strength for a predetermined number of the detected signals. In one embodiment, the second device is one of a number of second devices, the expected signal strength is the greatest signal strength detected by the number of second devices, and the second device is determined to be in the null point when the signal strength of the detected signal at the one of the number of second devices is less than the expected signal strength less a predetermined signal strength offset for the predetermined number of detected signals.

The RF unit 70 includes memory storage 72, a processor 74, a transmitter portion 76, and a receiver portion 78. The memory storage 72 can be any memory storage suitable for storing data and/or instructions. The memory storage 72 exchanges information with the processor 74, which controls operation of the RF unit 70. The transmitter portion 76 and receiver portion 78 communicate wirelessly with other RF units and/or central control centers, and can include antennas. The transmitter portion 76 can receive data and instructions from the processor 74, and transmit a signal from the RF unit 70. In one embodiment, the transmitter portion 76 is responsive to a command signal from the processor 74 to reduce transmission frequency when the processor 74 determines the receiver is in a null point and stationary with respect to the transmitter. Transmission frequency is defined herein as how often the transmitter transmits and is independent of the carrier frequency. The receiver portion 78 can receive a signal from outside the RF unit 70, and provide data and instructions to the processor 74. In one embodiment, the receiver portion 78 is responsive to a command signal from the processor 74 to reduce reception frequency when the processor 74 determines the receiver is in a null point and stationary with respect to the transmitter. Reception frequency is defined herein as how often the receiver receives and is independent of the carrier frequency. Reducing the transmission and/or reception frequency conserves power and extends battery life. The receiver needs to receive less often when the transmitter sends less often, so the receiver can be turned off when no signal is expected.

The RF unit 70 can operate as a transmitter, a receiver, or a transmitter and receiver. In one embodiment, the transmitter portion 76 can be omitted and the RF unit 70 operated as a receiver. In another embodiment, the receiver portion 78 can be omitted and the RF unit 70 operated as a transmitter. In one embodiment, the RF unit 70 operates under the ZigBee communications protocol operating on top of the IEEE 802.15.4 wireless standard. Those skilled in the art will appreciate that the RF unit 70 can operate under any wireless protocol desired for a particular application. In other embodiments, the RF unit 70 operates under the WiFi protocol under IEEE standard 802.11 (such as 802.11b/g/n), Bluetooth protocol, Bluetooth Low Energy protocol, or the like. When the RF unit 70 is both a transmitter and receiver, the receiver portion 78 can be turned off when the receiver portion 78 does not expect and/or need to receive a signal. The RF unit can be associated with another object, such as a lighting fixture, lighting control unit, asset to be tracked, a medical patient, or any other object. The RF unit can also control and/or monitor the associated object.

The RF unit 70 can send and receive signals at a single carrier frequency or at a number of carrier frequencies. Wavelength changes with carrier frequency, so the locations of the null points are different at different carrier frequencies. In one embodiment, the processor 74 can switch operation of the RF unit 70 between different carrier frequencies, so that the transmitter portion 76 is operable to transmit the signal at different carrier frequencies. Different null points can be found at different locations for different carrier frequencies by switching carrier frequencies for the RF units in the motion detection system. The processor 74 can be operable to determine that a receiver is in a null point when the signal strength of the detected signal is less than the expected signal strength for a predetermined number of detected signals at least one of the different carrier frequencies.

The processor 74 can be operable to allow the motion detection system to take a predetermined action when the receiver is determined to be in a null point and stationary with respect to the transmitter. In one embodiment, the processor 74 is operable to measure the time the receiver is determined to be in a null point and stationary with respect to the transmitter. The processor 74 can also be operable to initiate an alarm when the time the receiver is determined to be in a null point and stationary with respect to the transmitter is greater than a predetermined time. In another embodiment, the processor 74 is operable to detect an increase of the signal strength of the detected signal when the receiver is determined to be in a null point and stationary with respect to the transmitter. Such an increase can indicate the presence of a body near the transmitter and/or receiver which changes the location of the null point.

FIG. 3 is a block diagram of a motion detection system in accordance with the present invention. In this example, the motion detection system 80 includes a number of RF units 82 in communication with each other as indicated by the dashed lines. In one embodiment, at least some of the RF units 82 communicate with each other wirelessly. In another embodiment, at least some of the RF units 82 are hard wired to communicate with each other. At least one of the RF units 82 can also be in communication with an optional control unit 84. In another embodiment, the optional control unit 84 can be included in one of the RF units 82. The relative position of the RF units 82 and reflecting objects in their vicinity results in null points around the motion detection system 80. The RF units 82 can be fixed or moveable as desired for a particular application. In one embodiment, at least some of the RF units 82 are contained in a single housing.

FIG. 4 is a flowchart of a motion detection method in accordance with the present invention. The method 100 includes transmitting a signal 102, such as transmitting a signal from a transmitter; detecting the signal at a first device 104, such as a receiver; determining whether signal strength of the detected signal is less than an expected signal strength 106; transmitting at least one additional signal 108, such as transmitting at least one additional signal from the transmitter; detecting the at least one additional signal at the first device 110; determining whether signal strength of the detected at least one additional signal is less than the expected signal strength 112; and determining that the first device is in a null point 114 when the signal strength of the detected signals is less than the expected signal strength for a predetermined number of the detected signals. The method 100 can be carried out with a motion detection system as described in FIGS. 1-3 above.

Referring to FIG. 4, the first device, such as a receiver, can be one of a number of first devices, the expected signal strength can be the greatest signal strength detected by the first devices, so that one of the first devices is determined to be in the null point and stationary with respect to the transmitter when the signal strength of the detected signal at the one of the first devices is less than the expected signal strength less a predetermined signal strength offset for the predetermined number of detected signals. In one example, the predetermined signal strength offset is 15 dB. In another embodiment, the transmitting a signal comprises transmitting a signal from at least one of a number of second devices, such as a number of transmitters; the first device, such as a receiver, is one of a number of first devices; and each of the first devices is associated with one of the second devices as a radio frequency (RF) unit. Those skilled in the art will appreciate that there are different ways to determine the expected signal strength. In one embodiment, the expected signal strength is based on previous values of the detected signal strength, such as the previous value, an average of a number of the previous values, or a time weighted average of the previous values. In one embodiment, the expected signal strength is calculated by modeling the motion detection system and its surroundings. In one embodiment, the predetermined number of detected signals can be a predetermined number of consecutive detected signals.

The method 100 can further include taking a predetermined action when the first device, such as a receiver, is determined to be in a null point and stationary with respect to the second device, such as a transmitter. In one embodiment, the predetermined action is reducing transmission frequency for the second device when the first device is determined to be in a null point. Reducing transmission frequency conserves power at the transmitter. In another embodiment, the predetermined action is reducing reception frequency for the first device when the first device is determined to be in a null point. Reducing reception frequency conserves power at the receiver. In another embodiment, the predetermined action is measuring a time the first device is determined to be in the null point, and optionally initiating an alarm when the time measured is greater than a predetermined time. Measuring the time permits analysis of the time a tracked movable component attached to either the transmitter or receiver spends at a fixed location. This can be used to study how long a part is in an assembly station or how long a medical patient is resting quietly in bed. Initiating an alarm provides notice of a condition of concern when the movable component has not moved for a predetermined time, such as when the part has not moved from the assembly station or the medical patient has not been active.

The method 100 can further include detecting an increase of the signal strength of the detected signal when the first device is determined to be in the null point. When the receiver is determined to be in the null point and stationary with respect to the transmitter, an increase in signal strength can indicate the presence of a body near the transmitter and/or receiver which changes the location of the null point. The motion detection system can be used as an occupancy detector when the receiver is in a fixed position with respect to the transmitter.

The transmitting at least one additional signal 108 can further include transmitting signals of different carrier frequencies. The null points are at different locations at different carrier frequencies, so a receiver can be in a null point with respect to the transmitter at one carrier frequency and not in a null point with respect to the transmitter at a different carrier frequency. Shifting signals over a number of carrier frequencies can find different null points at different carrier frequencies, which can then be used to determine when the receiver is in a null point and stationary with respect to the transmitter. In one embodiment, the transmitting is performed a number of times at a carrier frequency, then the transmitting is performed a number of times at another carrier frequency different from the original carrier frequency.

In another embodiment, the carrier frequency is changed after each signal transmission, so that the signal is transmitted at a first carrier frequency, then a second carrier frequency, then a third carrier frequency, et cetera. The transmitting can be performed for a predetermined number of carrier frequencies to determine the expected signal strength. For example, the expected signal strength can be the highest signal strength detected for the different carrier frequencies. In another example, the expected signal strength can be a statistical product of the signal strengths detected over the predetermined number of carrier frequencies, such as the average of the signal strengths detected over the predetermined number of carrier frequencies. When the detected signal strength at one of the carrier frequencies is less than the expected signal strength less a predetermined signal strength offset, that carrier frequency can be identified as being associated with a null point. For an example using five as the predetermined number of carrier frequencies, the sequential signal strengths detected for different carrier frequencies could be −10, −11, −40, −5, and −10. The expected signal strength can be the highest signal strength detected, i.e., −5. The carrier frequency with a detected signal strength of −40 indicates a carrier frequency associated with a null point, because the detected signal strength of −40 is less than the expected signal strength of −5 less a predetermined signal strength offset, such as −15. The detected signal strength at the carrier frequency associated with a null point can be checked for a predetermined number of detected signals to determine whether the receiver is in a null point and stationary with respect to the transmitter. Those skilled in the art will appreciate that null points can occur for one receiver and transmitter pair at multiple carrier frequencies.

One implementation of the method uses two signals as the predetermined number of detected signals for which it is determined that the receiver is stationary with respect to the transmitter. The method includes transmitting a first signal, such as transmitting a first signal from a transmitter; detecting the first signal at a number of first devices, such as a number of receivers; determining a greatest signal strength of the first signal detected by the number of first devices; and determining that one of the number of first devices is in a null point when signal strength of the detected first signal at the one of the number of first devices is less than the greatest signal strength less a predetermined signal strength offset. The method further includes transmitting a second signal, such as transmitting a second signal from the transmitter; detecting the second signal at the number of first devices, such as the number of receivers; and determining that the one of the number of first devices is in the null point when signal strength of the detected second signal at the one of the number of first devices is less than the greatest signal strength less the predetermined signal strength offset. The one of the number of first devices can be determined to be stationary when the one of the number of first devices is in the null point for the first signal and the second signal. Those skilled in the art will appreciate that the predetermined number of detected signals can be selected to any number as desired for a particular application considering such factors as interference, environment, the selected predetermined signal strength offset, the number of approximately collocated receivers available, the degree of control over carrier frequency (e.g., the number of frequency channels used), the relative impacts of a false positive or false negative reading, and the like.

While the embodiments of the invention disclosed herein are presently considered to be preferred, various changes and modifications can be made without departing from the scope of the invention. The scope of the invention is indicated in the appended claims, and all changes that come within the meaning and range of equivalents are intended to be embraced therein.

1. A motion detection method comprising:
transmitting a signal;
detecting the signal at a first device;
determining whether signal strength of the detected signal is less than an expected signal strength;
transmitting at least one additional signal;
detecting the at least one additional signal at the first device;
determining whether signal strength of the detected at least one additional signal is less than the expected signal strength; and
determining that the first device is in a null point when the signal strength of the detected signals is less than the expected signal strength for a predetermined number of the detected signals.

2. The method of claim 1, wherein the transmitting a signal comprises transmitting a signal from a second device, the method further comprising reducing transmission frequency for the second device when the first device is determined to be in the null point.

3. The method of claim 1, further comprising reducing reception frequency for the first device when the first device is determined to be in the null point.

4. The method of claim 1, further comprising measuring a time the first device is determined to be in the null point.

5. The method of claim 4, further comprising initiating an alarm when the time is greater than a predetermined time.

6. The method of claim 1, further comprising detecting an increase of the signal strength of the detected signal when the first device is determined to be in the null point.

7. The method of claim 1, wherein the first device is one of a plurality of first devices operable to detect signals, the expected signal strength is the greatest signal strength detected by the plurality of first devices, and one of the plurality of first devices is determined to be in the null point when the signal strength of the detected signal at the one of the plurality of first devices is less than the expected signal strength less a predetermined signal strength offset for the predetermined number of the detected signals.

8. The method of claim 1, wherein the transmitting a signal comprises transmitting a signal from at least one of a plurality of second devices, the first device is one of a plurality of first devices, and each of the plurality of first devices is associated with one of the plurality of second devices as a radio frequency (RF) unit.

9. The method of claim 1, wherein the transmitting at least one additional signal further comprises transmitting signals of different carrier frequencies.

10. A motion detection system comprising:
a first device operable to transmit a signal;
a second device operable to detect the signal; and
a processor operable to determine whether signal strength of detected signals at the second device is less than an expected signal strength, and operable to determine that the second device is in a null point when the signal strength of the detected signals is less than the expected signal strength for a predetermined number of the detected signals.

11. The system of claim 10, wherein the first device is responsive to a command signal from the processor to reduce transmission frequency when the processor determines the second device is in a null point and

12. The system of claim 10 wherein the second device is responsive to a command signal from the processor to reduce reception frequency when the processor determines the second device is in a null point.

13. The system of claim 10 wherein the processor is operable to measure a time the second device is determined to be in a null point.

14. The system of claim 13 wherein the processor (74) is operable to initiate an alarm when the time is greater than a predetermined time.

15. The system of claim 10 wherein the processor is operable to detect an increase of the signal strength of the detected signal when the second device is in a null point.

16. The system of claim 10 wherein the second device is one of a plurality of second devices, the expected signal strength is the greatest signal strength detected by the plurality of second devices, and the second device is determined to be in the null point when the signal strength of the detected signal at the one of the plurality of second devices is less than the expected signal strength less a predetermined signal strength offset for the predetermined number of detected signals.

17. The system of claim 10 wherein the first device is operable to transmit the signal at different carrier frequencies, and the processor is operable to determine that the second device is in a null point when the signal strength of the detected signal is less than the expected signal strength for a predetermined number of detected signals at at least one of the different carrier frequencies.

18. A motion detection method comprising:
transmitting a first signal;
detecting the first signal at a plurality of first devices;
determining a greatest signal strength of the first signal detected by the plurality of first devices;
determining that one of the plurality of first devices is in a null point when signal strength of the detected first signal at the one of the plurality of first devices is less than the greatest signal strength less a predetermined signal strength offset;
transmitting a second signal;
detecting the second signal at the plurality of first devices;
determining that the one of the plurality of first devices is in the null point when signal strength of the detected second signal at the one of the plurality of first devices is less than the greatest signal strength less the predetermined signal strength offset; and
determining that the one of the plurality of first devices is stationary when the one of the plurality of first devices is in the null point for the first signal and the second signal.

19. The method of claim 18, wherein the transmitting a first signal comprises transmitting a first signal from a second device, the transmitting a second signal comprises transmitting a second signal from the second device, and further comprising reducing transmission frequency for the second device when the one of the plurality of first devices is determined to be stationary.

20. The method of claim 18, further comprising:
reducing reception frequency for the one of the plurality of first devices when the one of the plurality of first devices is determined to be stationary, and/or
measuring a time the one of the plurality of first devices is determined to be stationary.
